(19) United States
(12) Patent Application Publication
(10) Pub. No.: US 2024/0207975 A1
(43) Pub. Date: Jun. 27, 2024

(54) METHOD FOR WELDING GAMMA STRENGTHENED SUPERALLOYS AND OTHER CRACK-PRONE MATERIALS

(71) Applicant: Optomec, Inc., Albuquerque, NM (US)

(72) Inventors: Robert F. Wagner, Clover, SC (US); Scotty R. Baylor, York, SC (US); Scott D. Applegate, Clover, SC (US)

(73) Assignee: Optomec, Inc., Albuquerque, NM (US)

(21) Appl. No.: 18/288,326

(22) PCT Filed: Apr. 26, 2022
(86) PCT No.: PCT/US2022/026296

§ 371 Date: Oct. 25, 2023

Related U.S. Application Data
(60) Provisional application No. 63/179,889, filed on Apr. 26, 2021.

(51) Int. Cl. B23K 26/32; B23K 103/18

(52) U.S. Cl. CPC B23K 26/32; B23K 2103/26

(57) ABSTRACT

Methods for welding materials such as superalloys, hard-facing materials, and aluminides that are difficult to weld without cracking. Instead of welding one layer at a time on the weld surface like existing methods, the weld comprises stacks of weld beads that are first built up vertically to a desired weld height. After a first stack is produced, the weld surface is translated relative to the filler material source and a second adjacent stack is produced. The process is repeated, traversing the weld surface. The stacks are preferably deposited at an angle to the filler material deposition direction. By building the thickness of the weld first, the heat of welding is preferably concentrated into a sufficiently small area on the weld surface so that weld pre-heating is not required, and each portion of the weld and weld surface undergoes only one heating and cooling cycle, reducing cracking.

### CROSS-REFERENCE TO RELATED APPLICATIONS

This application claims priority to and the benefit of the filing of U.S. Provisional Patent Application No. 63/179,889, entitled “METHOD FOR WELDING GAMMA STRENGTHENED SUPER ALLOYS”, filed on Apr. 26, 2021, the entirety of which is incorporated herein by reference.

### BACKGROUND OF THE INVENTION

### Field of the Invention (Technical Field)

The present invention relates to the field of welding difficult to weld materials.

### DESCRIPTION OF RELATED ART

Note that the following discussion may refer to a number of publications and references. Discussion of such publications herein is given for more complete background of the scientific principles and is not to be construed as an admission that such publications are prior art for patentability determination purposes.

Nickel-based superalloys, along with many hard-facing materials, titanium aluminides, nickel aluminides and steels are very difficult to weld without cracking when used as a weld filler material. The cracking is related to many factors, including:
high thermal gradients between base metal and weld pool;
low ductility of the base metal and/or weld filler; and/or
precipitation of metallurgical phases during inter-layer cooling that crack when subsequent weld layers are applied.

Known methods require that the base material be pre-heated to elevated temperatures prior to welding and that the heat be maintained during welding to prevent cracking. For example, U.S. Pat. No. 5,554,837 describes a typical process and apparatus. FIGS. 1A-1D illustrate such a method. Deposition head 21 deposits first layer 4 of weld beads in a cross-hatch (or fill) pattern on the entire weld surface 2, as shown in FIG. 1A. In FIG. 1B, second layer 6 of weld beads is applied directly on top of first layer 4 in a cross-hatch (or fill) pattern on the entire weld surface 2. In FIG. 1C, third layer 8 of weld beads is applied directly on top of second layer 6 in a cross-hatch (or fill) pattern on the entire weld surface 2. In FIG. 1D, fourth layer 10 of weld beads is applied directly on top of third layer 8 in a cross-hatch (or fill) pattern to the entire weld surface 2. This is repeated with successive layers, each layer in a cross-hatch (or fill) pattern covering the entire weld surface 2, until the desired weld build height is achieved. An elevated temperature is preferably maintained during the weld cycle. However, multiple cooling and heating cycles with each successive layer are still present, since each weld bead (and the underlying weld surface) is heated up multiple times as successive layers are deposited over it, which may cause cracking.

### BRIEF SUMMARY OF THE INVENTION

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate the practice of embodiments of the present invention and, together with the description, serve to explain the principles of the invention. The drawings are only for the purpose of illustrating certain embodiments of the invention and are not to be construed as limiting the invention. In the drawings:

FIGS. 1A-D provide an overview of the prior art in which the weld is built in successive layers.

FIG. 2 is a perspective view of an airfoil in weld position.

FIGS. 3A-D provide an overview of the progression of an embodiment of weld motion of the present invention, building adjacent stacks of individual weld beads precisely aligned on top each other and progressing across the weld area in a single pass.

FIGS. 4A-D provide an overview of the progression of an embodiment of weld motion of the present invention with the weld area being level and the individual weld beads being deposited at an angle.

### DETAILED DESCRIPTION OF THE INVENTION

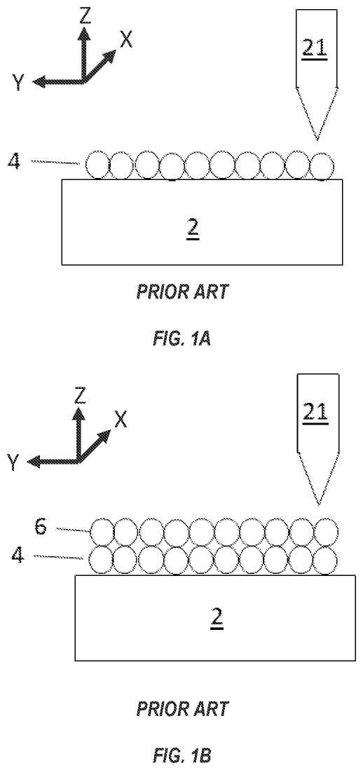

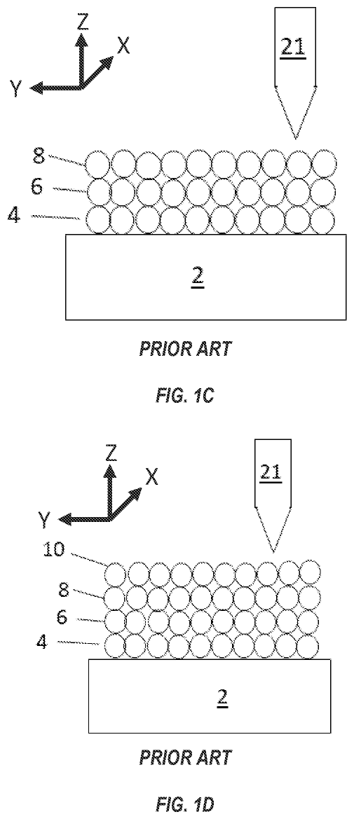

The present invention relates to processes for welding crack-prone materials using novel weld paths that preferably deploy a weld path hatch pattern that first builds the thickness of the weld, instead of the length of the weld as used in conventional welding (see FIGS. 1A-1D). The thickness of the weld is preferably achieved by stacking weld beads in a vertical or angled direction away from the weld surface. By building the thickness of the weld first, the heat of welding is preferably concentrated into a sufficiently small area such that weld pre-heating is not required. In addition, the weld material and adjacent base metal are subjected to a single heating cycle because the weld heat source traverses the weld surface one time. The weld bead stacks are preferably deposited at an angle to the laser beam axis (the vertical direction in the figures) so the previously completed stack does not block or shadow the laser beam at the start of the next stack.

The present invention has broad industrial applications that include any material that has improved weldability at elevated temperatures and/or cannot tolerate thermal cycles. For example, the stacked bead motion of the present invention can be used to weld hard face materials on Z-notches of turbine blades, or to weld turbine blade tips with hard to weld filler materials. In the prior art, such hard to weld filler materials often cause cracking. In contrast, the stacked bead weld processes of the present invention can weld many hard to weld filler and/or substrate materials, including, but not limited to, any gamma prime strengthened superalloy, hard to weld superalloys, hard-facing materials, titanium aluminides, nickel aluminides, and steels.

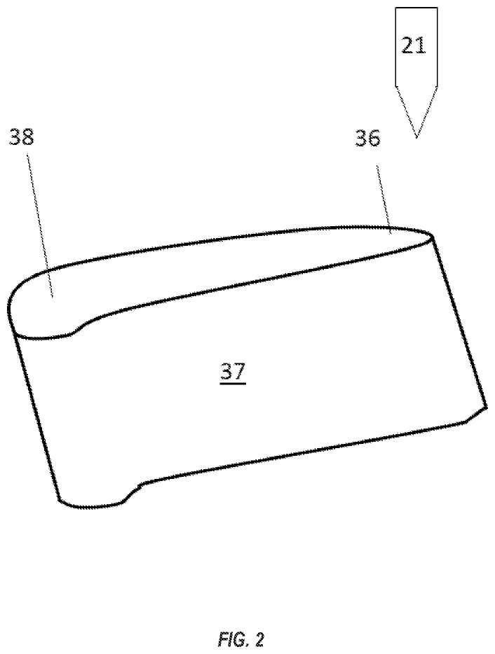

In an embodiment of the present invention, the surface to be welded is preferably positioned slightly angled to the X-Y plane of the motion system, contrary to conventional practice where the surface to be welded is positioned parallel to the X-Y plane of the motion system. FIG. 2 illustrates airfoil 37 at weld position. As in all of the figures, the X axis is perpendicular to the page, the Y-axis is in the horizontal direction, and the Z-axis is in the vertical direction. The weld surface is preferably angled from about 10° to about 45° to the Z-axis, and the laser beam and weld material deposition nozzle 21 are parallel to the Z-axis. The weld motion preferably begins at the trailing edge 36 and ends at the leading edge 38, because the trailing edge has a much smaller cross sectional thickness and heats up very quickly at the start of the welding. Alternatively, welding may start at leading edge 38. The weld is preferably accomplished in a single traverse of the weld surface; the completed weld thereby cools uniformly in one thermal cycle as the weld progresses from trailing edge to leading edge. This process reduces or eliminates cracking. The example of turbine blade repair is described herein as a means of illustration and is not to be construed as limiting the invention.

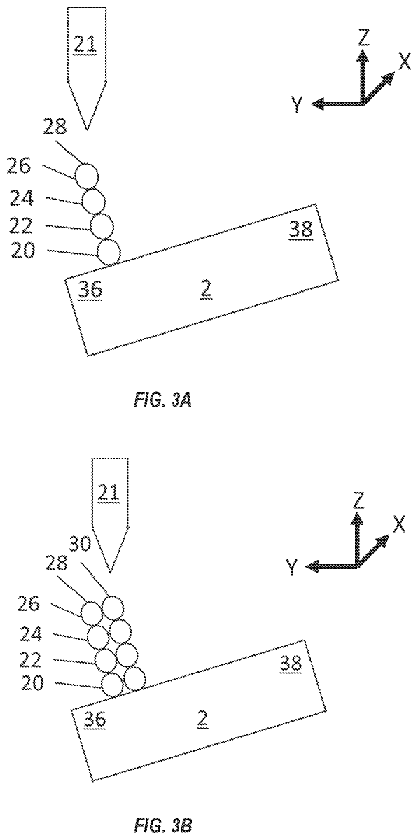

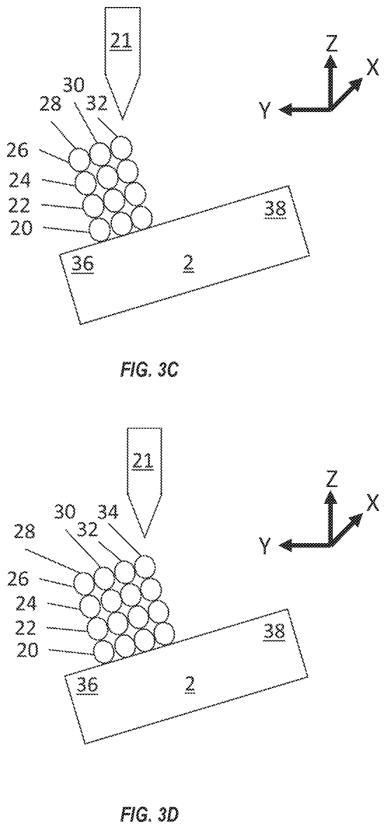

In one embodiment of the present invention, as shown in FIGS. 3A-3D, the weld surface is at an angle to the Z-axis and the adjacent stacks of individual weld beads are preferably precisely aligned on top of each other approximately perpendicular to the weld surface. In FIG. 3A, deposition nozzle 21 deposits weld beads preferably beginning at trailing edge 36 as opposed to leading edge 38 of weld surface 2, and produces first stack 28 of multiple bead layers 20, 22, 24, 26 upward from weld surface 2 by translating the weld surface and/or the laser beam and deposition nozzle relative to one another until the desired weld build height is achieved. The stacks can be printed at any angle from the weld surface. All weld bead layers 20, 22, 24, 26 of first stack 28 are preferably completed before starting the next adjacent second stack 30, as shown in FIG. 3B. After second stack 30 is built, adjacent third stack 32 is built, shown in FIG. 3C, followed by fourth stack 34, as shown in FIG. 3D. The stacks of individual weld beads are preferably precisely aligned on top of each other and progress across the weld area from trailing edge 36 to leading edge 38 in a single pass. Each stack of beads typically reaches about 2-4 mm in height, but any weld build height may be accommodated.

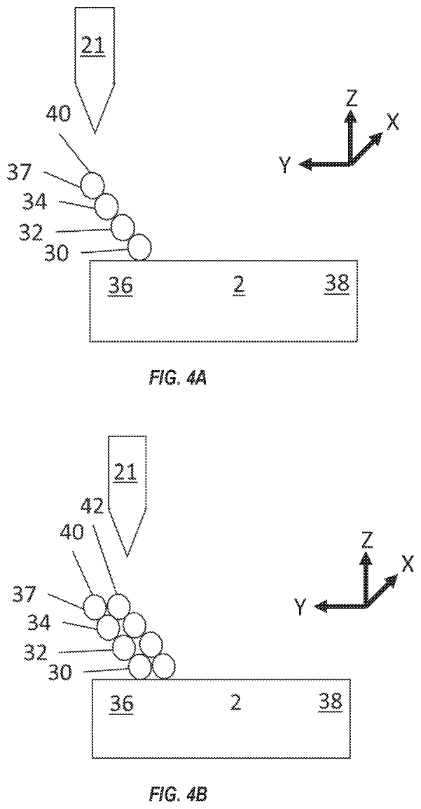

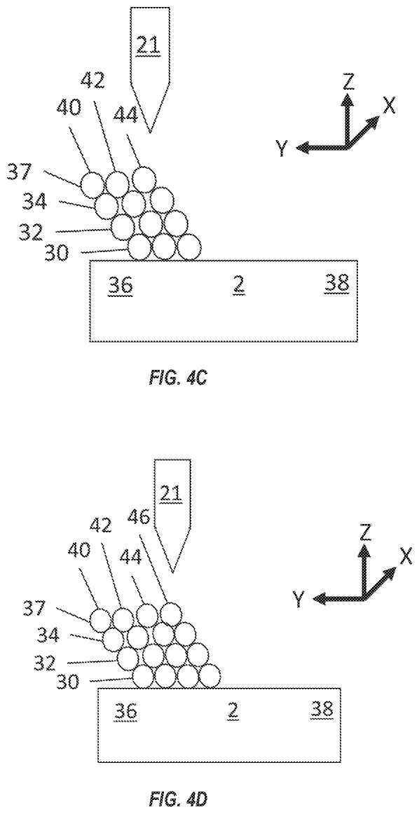

In an alternative embodiment of the present invention, as shown in FIGS. 4A-4D, the weld surface is approximately perpendicular to the Z-axis and the stacked beads are printed at an angle to the weld surface. The stacks are preferably deposited one by one, preferably progressing across the weld area in a single pass. In FIG. 4A, deposition nozzle 21 deposits weld beads preferably beginning at trailing edge 36 as opposed to leading edge 38 of weld surface 2, and produces first stack 40 of multiple bead layers 30, 32, 34, 37 upward and at an angle from weld surface 2, and preferably at an angle to both the laser beam and deposition nozzle 21, by translating the weld surface and/or the laser beam and deposition nozzle relative to one another until the desired weld build height is achieved. The stacks are preferably printed at 15°-45° from horizontal, but can be printed at any angle to the weld surface. All weld bead layers 30, 32, 34, 37 of first stack 40 are preferably completed before starting the next adjacent second stack 42, shown in FIG. 4B. After second stack 42 is built, adjacent third stack 44 is built, as shown in FIG. 4C, followed by fourth stack 46, shown in FIG. 4D. The stacks of individual weld beads are preferably precisely aligned at a set angle on top of each other and progress across the weld area from trailing edge 36 to leading edge 38 in a single pass. Each stack of beads typically reaches about 2-4 mm in height, but any height may be deposited.

Elimination of pre-weld heating is enabled by the motion of the stacked bead process of the present invention, which concentrates the heat of welding into a relatively small area. The heat from welding preferably sufficiently raises the temperature of the base metal and applies the weld so that pre-weld heating is not required. Furthermore, the processes of the present invention preferably concentrate the heat from the welding source (laser, electron beam, electric arc, etc.) such that the stack previously completed is still very hot when the next adjacent stack is deposited and welded, reducing thermal gradient of the melt pool and related solidification stresses that can cause cracking. With existing methods the previously applied weld layer cools before the next weld layer is applied. The cooled previous layer often cracks when subsequent layers are applied. The elimination of pre-weld heating dramatically simplifies the production process, reducing apparatus cost and processing cycle time. However, the present invention can be used in conjunction with weld pre-heating when required for particular applications.

The weld is preferably accomplished with one traverse of the weld area cross section, resulting in one heating and cooling cycle. In typical methods, the weld cools at dramatically different rates and through multiple heat/cool cycles associated with each layer of build height. In addition, a faster weld can be achieved than is typically possible with the existing methods. For example, a typical aviation turbine blade tip repair can be accomplished in less than 5 minutes using a CNC laser weld system in accordance with the present invention, reducing time by 15 to 20 minutes in comparison with existing methods.

Computer numerical control (CNC) laser welding systems typically have the capabilities to perform the novel stacked bead weld path of the present invention. Such systems are typically equipped with a vision system and cladding software. The cladding software preferably uses the dimensions of the weld area defined by the vision system to create the unique weld path CNC program that precisely controls motion, laser power, speed, and powder flow.

Note that in the specification and claims, “about” or “approximately” means within twenty percent (20%) of the numerical amount cited. As used herein, the singular forms “a,” “an,” and “the” include plural referents unless the context clearly dictates otherwise. Thus, for example, reference to “a functional group” refers to one or more functional groups, and reference to “the method” includes reference to equivalent steps and methods that would be understood and appreciated by those skilled in the art, and so forth.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A method for welding a weld surface of an article, the method comprising:
welding a first base weld bead to the weld surface;
moving a weld filler material source and/or the weld surface relative to each other;
welding a first stacking bead to the first base weld bead but not to the weld surface, thereby forming a first weld bead stack;
moving the weld filler material source and/or the weld surface relative to each other;
welding a second base weld bead to the weld surface and to the first base weld bead;
moving the weld filler material source and/or the weld surface relative to each other; and
welding a second stacking bead to the second base weld bead and the first stacking bead but not to the weld surface, thereby forming a second weld bead stack parallel to and adjacent to the first weld bead stack.

2. The method of claim 1 wherein a direction of each bead stack is not parallel to a deposition direction of weld material from the weld filler material source.

3. The method of claim 1 wherein a direction of each bead stack is perpendicular to the weld surface.

4. The method of claim 1 wherein the weld surface is not perpendicular to a deposition direction of weld filler material from the weld filler material source.

5. The method of claim 1 wherein all of the weld beads comprise a weld filler material.

6. The method of claim 5 wherein the weld filler material is selected from the group consisting of superalloy, nickel-based superalloy, gamma prime strengthened superalloy, hard-facing material, titanium aluminide, nickel aluminide, and steel.

7. The method of claim 1 wherein the weld surface comprises a surface of a turbine blade or airfoil.

8. The method of claim 7 wherein the first base weld bead is welded to the weld surface at a trailing edge of the turbine blade or airfoil, and one or more subsequent base weld beads are welded to the weld surface in a direction toward a leading edge of the turbine blade or airfoil.

9. The method of claim 1 performed without prior heating of the weld surface.

10. The method of claim 1 wherein the welding steps are performed using a laser, electron beam, or electric arc.

11. The method of claim 1 performed using a computer numerical control (CNC) machine.
